(19) United States
(12) Patent Application Publication
(10) Pub. No.: US 2021/0092058 A1
(43) Pub. Date: Mar. 25, 2021

(54) TRANSMISSION OF HIGH-THROUGHPUT STREAMS THROUGH A NETWORK USING PACKET FRAGMENTATION AND PORT AGGREGATION

(71) Applicant: Intel Corporation, Santa Clara, CA (US)

(72) Inventor: Marina Popilov, Herzlia (IL)

(73) Assignee: Intel Corporation, Santa Clara, CA (US)

(21) Appl. No.: 17/115,506

(22) Filed: Dec. 8, 2020

(51) Int. Cl. H04L 12/721; H04L 12/741; H04L 12/717; H04L 12/707; H04L 29/12

(52) U.S. Cl. CPC H04L 45/566; H04L 45/74; H04L 61/6022; H04L 45/24; H04L 45/42

(57) ABSTRACT

In one embodiment, a network interface controller includes processing circuitry and a set of ports to communicate over a network. The processing circuitry receives a request to send an Ethernet packet to a corresponding destination over the network. The payload of the Ethernet packet is partitioned into payload fragments, and fragmented Ethernet packets are generated for the payload fragments. Each fragmented Ethernet packet includes one of the payload fragments, a fragment header with a sequence number of the payload fragment, and an Ethernet frame header with a source media access control (MAC) address and a destination MAC address. The fragmented Ethernet packets are then sent to the corresponding destination over the network via multiple ports.

### FIELD OF THE SPECIFICATION

This disclosure relates in general to the field of computer networking, and more particularly, though not exclusively, to transmission of high-throughput streams over a network using packet fragmentation and port aggregation.

### BACKGROUND

The workloads of certain data center applications include network flows or sessions that require very high throughput, such as the video streams of a video streaming service. In particular, the video distribution industry produces a continuously growing demand for heavy workload transport availability to deliver these video streams, as the volume of video and media content being streamed every year continues to grow rapidly.

Transmission of a video stream through a data center can require significant network throughput or bandwidth. While the equipment and devices deployed in a data center typically include multiple network ports per device, the traffic of a single video stream is transmitted using a single port on each device. As a result, the video stream must be transmitted using a port that is fast enough to support the required throughput of the stream, which results in underutilization of certain slower ports.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a system for transmitting high-throughput network streams using packet fragmentation and port aggregation in accordance with various embodiments.

FIG. 2 illustrates an example of Ethernet-based packet fragmentation and port aggregation in accordance with certain embodiments.

FIG. 3 illustrates an example format of a fragmented packet in accordance with certain embodiments.

FIG. 4 illustrates an example embodiment of a computing device for sending and/or receiving high-throughput network streams using packet fragmentation and port aggregation.

FIG. 5 illustrates a flowchart for sending Ethernet packets over a network using packet fragmentation and port aggregation.

### EMBODIMENTS OF THE DISCLOSURE

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Transmission of High-Throughput Streams Through a Network Using Packet Fragmentation and Port Aggregation

The workloads of certain data center applications include network flows or sessions that require very high throughput, such as the video streams of a video streaming service. In particular, the video distribution industry produces a continuously growing demand for heavy workload transport availability to deliver these video streams, as the volume of video and media content being streamed every year continues to grow rapidly.

Video content is typically transported in raw or uncompressed form during production and when delivered to primary and backup storage, and then subsequently distributed to end-user or consumer devices in compressed and transcoded form. Transmission of a video stream, whether uncompressed or compressed, can require significant throughput or bandwidth. For example, a single uncompressed 4K video stream with 30, 60, or 120 frames per second (FPS) requires a link throughput of 12, 24, or 48 Gigabits per second (Gbps), respectively. Moreover, the next generation of high dynamic range (HDR) and ultra-high definition (UHD) video technology requires even more throughput. For example, even when compressed and transcoded, HDR/UHD video requires throughput of over 1 Gbps for each session or flow.

The equipment deployed in a data center—such as a computing device, server, node, switch, or router—typically includes multiple ports per device with speeds of 1 Gbps, 2.5 Gbps, 10 Gbps, 25 Gbps, 40 Gbps, and/or 100 Gbps. The traffic of a single video stream, however, cannot be split over the available ports or links of an individual device. For example, since a video stream is transported through the data center network in a single unicast or multicast session via layer 2 (L2) (data link layer), layer 3 (L3) (network layer), and/or layer 4 (L4) (transport layer) of the Open Systems Interconnection (OSI) model, any L2-L3-L4 hash tuple will produce the same sticky result for all packets in the same stream, which means those packets will all be mapped to the same port.

As a result, each device in the data center must transmit a video stream via a single port that is fast enough to support the required throughput of the stream. For example, an uncompressed 4K stream with a required throughput of 12-48 Gbps must be transmitted using a port that is faster than 10 Gbps, such as a 25 Gbps, 40 Gbps, or 100 Gbps port. Similarly, a compressed 4K stream with a required throughput above 1 Gbps must be transmitted using a port that is faster than 1 Gbps, such as a 2.5 Gbps or 10 Gbps port.

This results in underutilization of the ports that are too slow to support the requisite throughput of a particular workload, such as 1 Gbps, 2.5 Gbps, and 10 Gbps ports that are too slow to support the throughput of an uncompressed 4K video stream. Thus, there is a strong economic incentive to enable these lower-speed ports to be utilized even when the required throughput of a workload exceeds the link speed supported by each port.

The potential solutions to this problem using current technologies, however, suffer from various drawbacks. For example, one potential solution would be to address this problem at the application level. In particular, application payload information could be used to split the traffic into separate sub-flows using control information transmitted within packets. For example, a video stream could be split into multiple channels, such as left, right, audio, and/or video channels. One problem with this solution is that the channels will have different throughput, and when delivered separately, they will require heavy buffering capabilities at the termination point and there will be a delay aligned with the speed of the slowest channel or sub-flow. Another problem with this solution is that deep packet inspection (DPI) payload parsing must be implemented on a per-application basis, which means an additional development cycle is required for any application that seeks to leverage this solution. Moreover, once developed, this solution is expensive in terms of computing resources and processing time.

Another potential solution is to use packet fragmentation and/or link aggregation/bonding technologies, such as Ethernet in the First Mile (EFM) bonding (IEEE 802.3ah) or the Multilink Point-to-Point Protocol (MLPPP). EFM bonding and MLPPP are technologies that can be used to implement packet fragmentation and link aggregation/bonding in access/backhaul networks and/or data centers. For example, aggregation (or bundling/bonding) is performed at layer 1 (L1) (physical layer) over different underlay transports (e.g., synchronous technologies such as xDSL and E1/T1, asynchronous technologies such as ATM), for Ethernet as a workload, or for IP as a workload with the additional overhead of a PPP tunnel. The end goal of EFM bonding, MLPPP, and other similar aggregation schemes is to enable slow speed links to be utilized as part of the network while maximizing bandwidth and minimizing total delay. However, these technologies have various disadvantages when used to address the problem described above.

In particular, EFM bonding is a point-to-point last mile/first mile solution that leverages link aggregation between a telecommunications service provider and its customers. As applied to slow speed xDSL bundles (symmetric and asymmetric), for example, EFM bonding can be used to aggregate multiple links (with a 1:4 speed ratio) between the access network of a service provider and the premises of a customer. Using EFM bonding, an Ethernet packet is split into fragments, each fragment is encapsulated with a header that has a specific EFM bonding format, and the fragments are then transmitted point to point over multiple links between two specialized devices that support the EFM bonding standard. The EFM bonding header does not include any source address and destination address information, however, which means the EFM fragments can only be transmitted directly between the two specialized devices that support EFM bonding, without passing through any intermediate devices. As a result, EFM bonding is a point-to-point solution that only works between two specialized devices. The EFM fragments cannot traverse layer 2 (L2) or layer 3 (L3) of a network, as they cannot be switched/routed by standard L2/L3 equipment, such as L2 switches and L3 routers.

MLPPP, on the other hand, is a link aggregation technology that spreads traffic across multiple links using PPP and multilink tunnels. While MLPPP is capable of traversing an L2/L3 network, the use of PPP and multilink tunnels requires high overhead and reduces the L3 maximum transmission unit (MTU) size to 1500 bytes (B). Moreover, MLPPP is unavailable for Ethernet transport equipment, as MLPPP equipment historically utilizes technologies such as ATM, T1/E1, and xDSL.

Multipath Datagram Congestion Control Protocol (MP-DCCP) is another technology that leverages multiple paths between peers to achieve higher throughput and improved resilience to network failure. MP-DCCP is primarily used for heterogenous media networks with various different types of access interfaces. Moreover, MP-DCCP is implemented by extending layer 3 (L3) routing capabilities in the network layer using a layer 4 (L4) tunnel solution in the transport layer. The MP-DCCP tunneling solution, however, has high cost and processing overhead due to the equipment modifications, parsing depth, and error-correction calculations that are required to implement the inner L4 tunnel.

Link aggregation is also supported by certain cell-based fabrics, but those technologies are irrelevant for purposes of deployment in contemporary enterprise data center networks, as modern networks rely primarily on Ethernet rather than cell-based fabrics.

Accordingly, this disclosure presents a solution for transmitting high-throughput streams over a network using packet fragmentation and port aggregation. In particular, the proposed solution leverages packet fragmentation and port aggregation at layer 2 (data link layer) of the OSI model, which enables the traffic of a high-throughput stream to be split across multiple ports or links—and traverse through a network via standard L2/L3 switching and routing equipment—without significant overhead. In this manner, the proposed solution enables underutilized ports to be reclaimed and collectively utilized to transmit a high-throughput stream that exceeds the speed of each individual port.

The proposed solution provides numerous advantages over other solutions. For example, the proposed solution enables a large volume of underutilized legacy equipment in data centers (e.g., servers with slow ports) to be utilized more efficiently even for modern workloads that require very high network throughput (e.g., video streaming workloads). This provides substantial economic benefits and costs savings for businesses and enterprises of all sizes.

Further, unlike link aggregation technologies such as EFM bonding, the proposed solution provides link aggregation over a regular L2 switching network, which means the streams can traverse through the network via standard L2/L3 switching and routing equipment.

The proposed solution is also more efficient and requires less overhead than other available technologies. For example, the proposed solution requires significantly less network overhead than technologies such as MLPPP.

Similarly, the proposed solution requires significantly less processing overhead than technologies such as MP-DCCP. For example, MP-DCCP relies on a layer 4 (transport layer) tunnel to extend layer 3 (network layer) routing capabilities, while the proposed solution utilizes a layer 2 (data link layer) tunnel over a standard L2 switching network. The processing overhead on the endpoints is significantly cheaper for the layer 2 (L2) solution. This is due to the parsing depth, the network modification cost (insertion of an outer L2 tunnel for the proposed solution versus an inner L4 tunnel for MP-DCCP), and the computing cost for performing error correction (L2 CRC checksum calculations for the proposed solution versus L2/L3/L4 checksum calculations for MP-DCCP). In addition, the proposed L2 solution enables the L2 switch network bus to be used in the deployment, which is orders of magnitude cheaper than using the L3 switch (routing) network bus as required by MP-DCCP (e.g., up to ten times (10×) cheaper in some cases). Further, MP-DCCP is primarily used for heterogenous media networks with various different types of access interfaces. The proposed solution, however, is targeted for homogenous media networks (e.g., on-premises and/or in data centers) to address changes in network workload characteristics (e.g., streaming throughput growth above NIC port speeds) by utilizing the existing network, without a need to change infrastructure or end-user applications.

Further, compared to cell-based fabrics, the proposed solution does not replace L2 packet switching principles with L2 fragments switching. Rather, the proposed solution applies multiple-input multiple-output (MIMO) principles on L2 Ethernet traffic to enable packet fragmentation and link aggregation on top of a standard L2/L3 network. For example, a single Ethernet packet is divided into multiple fragments, and the fragments are transmitted as separate Ethernet packets—with the fragments as payloads—through multiple interfaces and collected over multiple inputs/outputs. A primary advantage of this approach is that it can coexist within native Ethernet-based networks as an add-on feature—it does not require existing networks and equipment to be replaced.

While the proposed solution is primarily described in connection with video streams, it can be applied to any type of network traffic or stream in various other embodiments and/or use cases. For example, the proposed solution is particularly beneficial to any type of non-balanceable network stream that cannot be easily divided and delivered in pieces at the application layer (e.g., in chunks) and/or at the routing/bridging layer (e.g., in packets), whether due to excessive compute requirements, development expenses, lack of technical feasibility, and/or any other reason.

Moreover, in contrast to the L3/L4 tunnels implemented by other standards (e.g., MLPPP or MP-DCPP), the proposed solution leverages L2 tunnels—and optionally L3 tunnels—that are more suitable and less expensive for contemporary data centers (e.g., enterprise and/or cloud service provider (CSP) data centers).

The proposed solution also improves on the 802.3ah EFM L2 fragmentation standard by enabling L2 fragments to traverse through a network by passing through existing network devices, such as L2 switches and L3 routers.

Further, the proposed solution enables all available Ethernet ports to be utilized regardless of their characteristics or suitability for a particular application workload, which improves the overall utilization of Ethernet ports on the devices in a data center and reduces the overall cost. For example, Ethernet ports that are individually too slow to satisfy the required network throughput of a workload can be combined or aggregated to collectively achieve the required throughput.

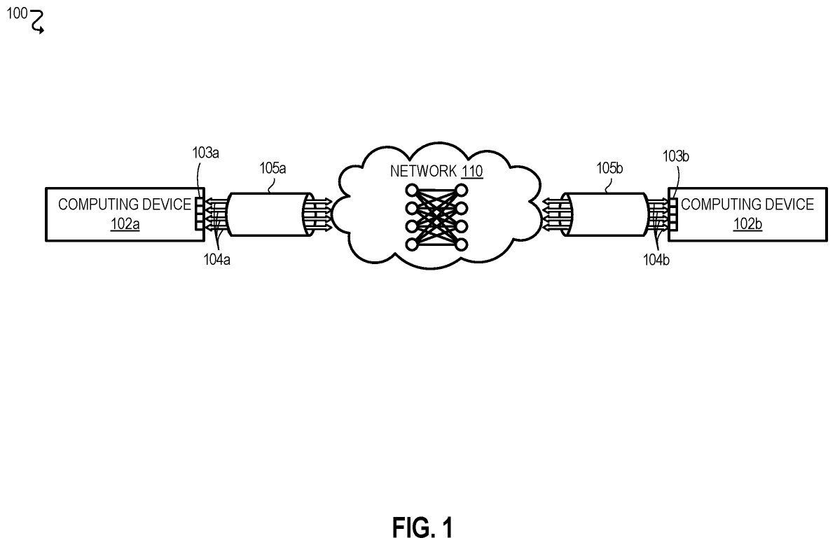

FIG. 1 illustrates a system 100 for transmitting high-throughput network streams using packet fragmentation and port aggregation in accordance with various embodiments. In the illustrated embodiment, for example, data streams are transmitted over a network 110 between computing devices 102a,b using multiple ports 103a,b and corresponding physical links 104a,b. For example, each computing device 102a,b includes a set of ports 103a,b and corresponding physical links 104a,b to communicate over the network 110. Moreover, these ports 103a,b and physical links 104a,b can be aggregated together to form a single logical link 105a,b between each computing device 102a,b and the network 110. For example, the ports 103a and physical links 104a of computing device 102a can be aggregated into a single logical link 105a between computing device 102a and the network 110. Similarly, the ports 103b and physical links 104b of computing device 102b can also be aggregated into a single logical link 105b between computing device 102b and the network 110.

In this manner, when the required throughput of a data stream exceeds the speed of the available ports 103a,b on either computing device 102a,b, the traffic of the data stream can be spread across the respective ports 103a,b and corresponding physical links 104a,b of that computing device 102a,b using packet fragmentation and port aggregation techniques. This enables slower and underutilized ports 103a,b of the computing device 102a,b to be aggregated together into a single logical link 105a,b to collectively send and/or receive the high-throughput stream. Moreover, in some embodiments, packet fragmentation may be implemented at layer 2 (data link layer) of the OSI model, which minimizes overhead and enables the fragmented packets to traverse through the network 110 via standard L2/L3 switching and routing equipment.

In some embodiments, for example, each layer 2 (L2) Ethernet packet in a data stream is split into multiple fragments, and each fragment is transmitted as a separate Ethernet packet, which is referenced throughout this disclosure as a “fragmented Ethernet packet.” Moreover, each fragmented Ethernet packet may include:
(i) a fragment of the payload of the original Ethernet packet, which is referenced throughout this disclosure as a “payload fragment”; and
(ii) a header that enables the fragmented packet to traverse through the network 110 (e.g., via standard L2/L3 equipment) and subsequently be reassembled into the original Ethernet packet.

In some embodiments, for example, the header of a fragmented Ethernet packet may include a layer 2 (L2) (data link layer) header, an optional layer 3 (L3) (network layer) header, and a fragment header.

The L2 header contains L2 source and destination addresses, which enables the fragmented packet to traverse through the network 110 via L2 switching equipment. In some embodiments, for example, the L2 header may include an Ethernet frame header with source and/or destination media access control (MAC) addresses.

The optional L3 header may be included to enable the fragmented packet to traverse through the network 110 via standard L3 routing equipment. In some embodiments, for example, the L3 header may include an Internet Protocol (IP) header with source and/or destination IP addresses.

Moreover, the fragment header contains information that enables the payload fragment in the fragmented packet to be reassembled into the payload of the original Ethernet packet. In some embodiments, for example, the fragment header may contain a sequence number of the corresponding payload fragment, along with flags indicating whether the payload fragment corresponds to the start, middle, and/or end of the original Ethernet frame or packet.

In this manner, when the required throughput of a data stream exceeds the speed of the available ports 103a,b on the computing devices 102a,b, each Ethernet packet in the stream can be partitioned into multiple fragmented Ethernet packets, and the fragmented Ethernet packets can then be spread across the respective ports 103a,b of computing devices 102a,b. This enables slower, underutilized ports 103a,b of the computing devices 102a,b to be aggregated together to collectively send and/or receive the high-throughput stream.

The packet fragmentation and port aggregation functionality can also be used to transmit Ethernet packets or frames with a large size, such as Ethernet packets containing jumbo Ethernet frames (e.g., over 1500 bytes). In some embodiments, for example, a jumbo Ethernet packet or frame can be partitioned into smaller fragments, such as fragments having the same or a similar size as a typical or standard Ethernet packet, and those fragments can then be spread across the respective ports 103a,b of computing devices 102a,b.

The proposed solution is primarily described throughout this disclosure with reference to Ethernet as the underlying physical layer transport. In particular, the description and examples primarily assume that fragmentation is performed on an Ethernet workload, suitable not only for point-to-point (PPP) transmissions, but also for enabling L2 network traversal (switching). In other embodiments, however, the proposed solution can be applied more broadly to any physical layer technology and/or physical transmission medium (e.g., as shown and described in connection with FIG. 3).

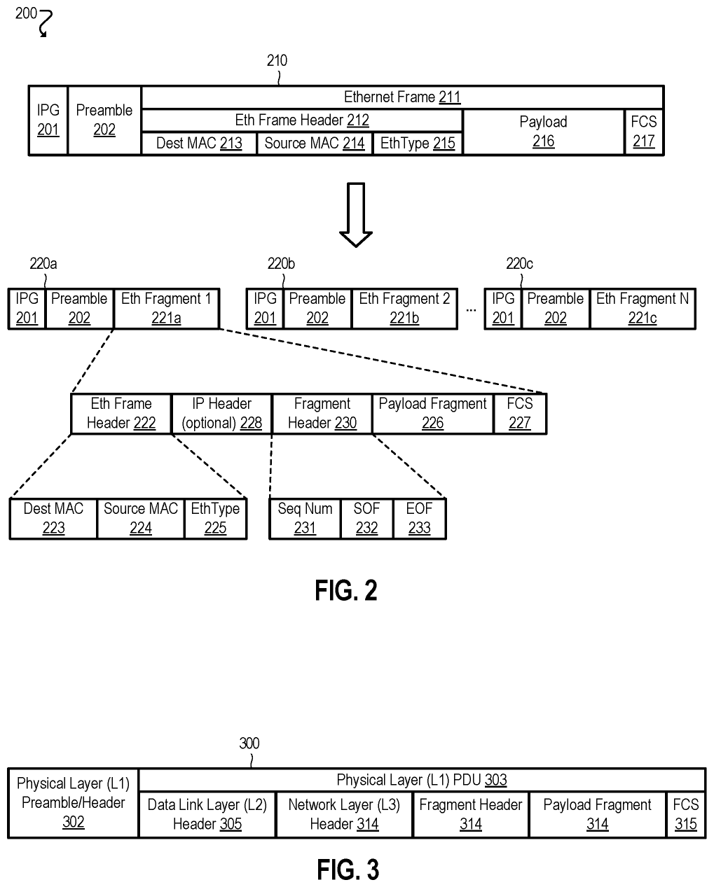

FIG. 2 illustrates an example 200 of Ethernet-based packet fragmentation and port aggregation in accordance with certain embodiments. In particular, the illustrated example shows how a single Ethernet packet 210 can be partitioned into multiple fragmented Ethernet packets 220a-c for transmission across a group of aggregated ports.

As described further below, the Ethernet-based packet fragmentation and port aggregation functionality involves the following functional aspects:
(i) packet fragmentation;
(ii) tunneling;
(iii) port grouping and bonding; and
(iv) load balancing.

In the illustrated example, the original Ethernet packet 210 includes an inter-packet gap (IPG) 201, an Ethernet preamble 202, and an Ethernet frame 211; the Ethernet frame includes an Ethernet frame header 212, a payload 216, and a frame check sequence (FCS) 217; and the Ethernet frame header 212 includes a destination MAC address 213, a source MAC address 214, and an Ethernet Type (EthType) field 215.

Moreover, in the illustrated example, the original Ethernet packet 210 is split or fragmented into multiple fragmented Ethernet packets 220a-c, which are capable of being separately transmitted or spread across a set of bonded ports. For example, the Ethernet packet 210 can be split or fragmented toward the wire on the sender side (source) and then subsequently reassembled from the wire on the receiver side (destination).

In particular, on the sender side, the payload 216 of the original Ethernet packet 210 is first partitioned into multiple payload fragments 226. The payload fragmentation can be implemented using any suitable approach, including the EFM bonding/fragmentation principles defined in IEEE 802.3ah and/or the fragmentation methods described below.

In some embodiments, for example, each payload fragment 226 may be a container with a variable size, such as 256, 512, 1024, 2048, and/or 4096 bytes (B). Moreover, depending on the particular method of fragmentation, the particular container or fragment size may be statically or dynamically assigned. For example, the fragmentation can be performed using various methods, such as overhead optimized fragmentation, throughput optimized fragmentation, and/or jitter optimized fragmentation, as described below.

Overhead optimized fragmentation dynamically adjusts—depending on the size of the maximum transmission unit (MTU) (e.g., 1500-9000 bytes for jumbo frames)—the maximum container size of the fragments to yield the minimum number of fragments (but at least two), with a tail fragment of a minimal suitable size.

Throughput optimized fragmentation is driven by the size of the group of bonded ports (e.g., up to 10 members/ports)—the number of fragments is calculated and the lowest container size is chosen to send the maximum number of fragments possible, limited by the original packet size.

Jitter optimized fragmentation simply generates fragments using a fragment size that is statically chosen.

The resulting payload fragments 226 are then encapsulated as Ethernet fragments 221a-c, which include various types of information for transmission and subsequent reassembly of the payload fragments 226, such as an Ethernet frame header 222 and/or an optional IP header 228, a fragment header 230, and a fragment check sequence (FCS) 227.

For example, as described further below, the Ethernet frame header 222 and an optional IP header 228 enable the Ethernet fragments 221a-c to traverse from source to destination through a network rather than requiring a direct point-to-point link.

Moreover, the fragment header 230 enables the payload fragments 226 to be subsequently reassembled into the payload 216 of the original Ethernet packet 210 on the receiving end. In some embodiments, for example, the fragment header 230 (e.g., 2 bytes) may include a sequence number 231 of a corresponding payload fragment 226, a start of frame (SOF) flag 232, an end of frame (EOF) flag 233, and an optional retransmission flag (not shown).

The sequence number 231 identifies the order or location of a corresponding payload fragment 226 within the sequence or collection of payload fragments, which enables the payload fragments to be reassembled in the correct order on the receiving end for reconstruction of the original payload 216.

The start of frame (SOF) 232 and end of frame (EOF) 233 flags indicate whether the corresponding payload fragment 226 corresponds to the start or the end of the original Ethernet frame 211 or payload 216. For example, if the SOF flag 232 is set, then the payload fragment 226 is the first fragment of the original frame 211 or payload 216. If the EOF flag 233 is set, then the payload fragment 226 is the last fragment of the original frame 211 or payload 216. If neither flag is set, then the payload fragment 226 is somewhere in the middle of the original frame 211 or payload 216.

The fragment check sequence (FCS) 227 contains an error detection and/or correction code for detecting and/or correcting errors in a corresponding payload fragment 226 during transmission. In some embodiments, for example, the FCS 227 may contain a cyclic redundancy check (CRC) checksum calculation for the payload fragment 226.

The resulting Ethernet fragments 221a-c are then packetized and transmitted as fragmented Ethernet packets 220a-c, with an inter-packet gap (IPG) 201 and Ethernet preamble 202 preceding each Ethernet fragment 221a-c. In this manner, the fragmented Ethernet packets 220a-c are transmitted separately, which enables them to be spread across a set of bonded ports on the sending and/or receiving end.

Reassembly of the original Ethernet packet payload 216 at the destination requires the incoming fragmented Ethernet packets 220a-c to be buffered on the receiving end. For example, the Ethernet fragments 221a-c in the incoming packets 220a-c may be stored in a buffer at the destination until all fragmented packets 220a-c have been received. Once all fragmented packets 220a-c have been received, the payload fragments 226 can be extracted from the buffered Ethernet fragments 221a-c (e.g., by popping the header/tail of the Ethernet fragments 221a-c), and the original payload 216 can be reconstructed from the extracted payload fragments 226 based on the information in the fragment headers 230. For example, the sequence number 231, start of frame (SOF) flag 232, and end of frame (EOF) flag 233 in the fragment headers 230 can be used to reassemble the payload fragments 226 in the proper order and reconstruct the original packet payload 216.

Unlike EFM bonding, which can only deliver fragments over a direct point-to-point link between two specialized devices, the fragmented Ethernet packets 220a-c leverage a tunneling mechanism to enable them to traverse through a network via existing network equipment, such as L2 switches and L3 routers. In the illustrated embodiment, for example, the Ethernet frame header 222 and the optional IP header 228 enable the fragmented Ethernet packets 220a-c to traverse through a network—via existing layer 2 switches and optionally layer 3 routers—rather than requiring a direct point-to-point link between the source and destination.

For example, each Ethernet fragment 221a-c is enveloped as normal Ethernet packet with a standard Ethernet frame header 222 and tail (e.g., a 4 byte FCS checksum 227). In this manner, the destination MAC address 223 (6 bytes) and source MAC address 224 (6 bytes) in the Ethernet frame header 222 enables each Ethernet fragment 221a-c to traverse through the L2 network. Moreover, the Ethernet Type (EthType) field 225 (2 bytes) in the Ethernet frame header 222 can be used to indicate that this is a special type of fragmented Ethernet packet (e.g., using a reserved value for future standardization of this feature) rather than a normal Ethernet packet or EFM bonding fragment.

Moreover, in some embodiments, each Ethernet fragment 221a-c may also include a layer 3 (L3) or network layer header, such as an Internet Protocol (IP) header 228 with source and/or destination IP addresses, which enables the fragment to traverse through the L3 network.

The group of ports used to transmit the fragmented Ethernet packets can be determined using port grouping and bonding principles with adjustments for Ethernet as the underlying transport medium (which is different from EFM and MLPPP transports). For example, ports that are grouped into a bonded link can have different speeds. In some embodiments, for example, ports with speeds that differ by a ratio of up to 1:16 can be bonded together, thus enabling combinations of 1 Gbps-10 Gbps ports, 2.5 Gbps-40 Gbps ports, and so forth. The operational state of the members of a group of ports is monitored continuously (e.g., up/running vs. unavailable), and the fragmented Ethernet packets are only transmitted on the active ports. In the event one of the ports chosen for transmission fails, the fragments assigned to that port can either be retransmitted on another port or lost/discarded. Depending on the chosen method of failure handling, the header of those fragments may be updated accordingly (e.g., to assign a source MAC address corresponding to another port).

Load balancing can be achieved using a variety of methods designed to evenly spread or distribute the fragments across the aggregated ports. The particular method of load balancing, however, may depend on how the destination/source MAC addresses 223, 224 are assigned to the fragmented Ethernet packets 220a-c.

In some embodiments, for example, load balancing may be performed using a round robin scheme, particularly if the destination/source MAC addresses 213, 214 in the original Ethernet packet 210 are reused as the destination/source MAC addresses 223, 224 of the fragmented Ethernet packets 220a-c.

For example, the destination MAC address 213 of the original Ethernet packet 210 is typically determined by the host that originated the packet based on a routing function. Thus, in some embodiments, the original destination MAC address 213 may simply be reused as the destination MAC address 223 in the fragments 220a-c for tunneling purposes. In this manner, all fragments 220a-c associated with the same original packet 210 would have the destination MAC address of the bonded port on the other end.

Similarly, the source MAC address 214 of the original Ethernet packet 210 typically corresponds to the local port MAC address configured on the network interface controller (NIC) of the host that originated the packet. Thus, in some embodiments, the original source MAC address 214 may simply be reused as the source MAC address 224 in the fragments 220a-c for tunneling purposes.

In the reverse direction, the bonded port on the receiving (Rx) end uses the destination MAC address, sequence number, and flags of each fragment to collect and reassemble the various fragments of the original packet across the bonded ports according to the internal algorithm.

In these embodiments, where the original Ethernet packet 210 and the fragmented packets 220a-c share the same destination/source MAC addresses, load balancing may be performed using a round robin scheme. In particular, round robin is a simple and effective load balancing scheme, and other load balancing schemes may be ineffective when the original MAC addresses are reused in the fragmented packets. For example, the use of stickiness methods for load balancing (e.g., distributing fragments across ports based on hashes of persistent packet content), if applied incorrectly (e.g., using L2/L3/L4 header fields for the hash), will significantly reduce or even altogether eliminate the performance gains of this solution, as the same L2 link/port will be used to send the entire flow if it is distinguished based on shared L2-L4 fields.

Accordingly, in some embodiments, a round robin scheme may be used. For example, each port may include a short input queue capable of storing a small number of fragments (e.g., 1-2 fragments in some cases), and the transmission (Tx) scheduler of the NIC may send fragments to the 1^{st} empty queue, iterating through them in a round robin fashion.

Alternatively, in some embodiments, load balancing may be performed using a hash stickiness method, particularly if the fragmented Ethernet packets 220a-c do not all share the same destination/source MAC addresses 223, 224. In particular, the addition of a layer 2 Ethernet header 222 to each fragment not only enables the fragments to traverse through the L2 network, it also enables improved control over the distribution of fragments across the network for load balancing purposes.

For example, with respect to the destination MAC address, a bonded port can have multiple destination MAC addresses assigned to the same port or group of ports, which all correspond to the same final destination from the perspective of the sender (e.g., a server or switch). Thus, in some embodiments, a set of destination MAC addresses corresponding to the same final destination can be distributed across the fragments rather than having the same destination MAC address for every fragment. Using a list of destination MAC addresses instead of only one destination MAC address enables entropy to be increased and traffic to be spread more fairly, but with the original 5-tuple flow identified stickiness factor required to reassemble the fragments of packets in the flow. This mechanism is similar to equal-cost multi-path routing (ECMP), but the L2 address is resolved on a per packet/fragment transmission basis.

In some embodiments, for example, the original destination MAC address 213 can be used to discover a group of MAC addresses associated with the same final destination. For example, the group may be statically provisioned on each NIC, or automatically distributed over the network, such as using the Link Layer Discovery Protocol (LDDP) (e.g., with a new type-length-value (TLV)) or other standard/proprietary L2 control protocols, running over reserved MAC addresses. Moreover, the original 5-tuple L3/L4 fields can be used to calculate the hash result. In this manner, the hash result in the chosen group can be resolved into a corresponding hash bucket to determine the specific destination MAC address to be applied.

With respect to the source MAC address, a bonded port typically has its own MAC address, which is used to locally sign the L2 address of packets. The source MAC address 224 of the fragments, however, does not necessarily have to be the same as the original source MAC address 214 of the port. Instead, a group of MAC addresses 224 corresponding to the same source can be used to sign the fragmented packets. The selection or assignment of the source MAC addresses from the group does not require stickiness—those addresses can be assigned to fragments using a round robin scheme. In this manner, a load balancing scheme can be applied (e.g., by L2 switches) on fragments that traverse the network as packets using the source MAC address 224—or both the source and destination MAC addresses 224, 223 (e.g., via an exclusive OR (XOR) operation on the source/destination MAC addresses)—of each fragment.

In the reverse direction, as explained above, the destination MAC address(es) are used to identify fragments of the same packet and the same flow (e.g., based on the 5-tuple stickiness used to determine the destination MAC addresses of the fragments).

In various embodiments, the packet fragmentation and port aggregation functionality described throughout this disclosure may be implemented via any suitable combination of hardware and/or software, such as a network interface controller (NIC) and/or an associated software driver.

In some embodiments, for example, the solution may be implemented in a software driver for an existing NIC, such that it is completely transparent to the underlying NIC hardware. For example, a software driver for an existing NIC may be programmed to perform packet splitting and reassembly and the corresponding encapsulation and decapsulation of fragments.

Alternatively, in some embodiments, the solution may be partially and/or fully implemented in the NIC hardware. For example, some or all aspects of the solution may be performed by the NIC hardware itself, such as the modification function (e.g., encapsulation/decapsulation), the split/reassembly functionality, and/or the buffering functionality on the receiving end (Rx) (toward the host), while the remaining functionality (if any) may be performed by the software driver. Moreover, in various embodiments, the functionality performed by the NIC hardware may be implemented using the existing hardware/processing capabilities of the NIC, such as hardware offload features of a smart NIC, or the functionality may be implemented directly in the hardware logic of a NIC (e.g., via an updated hardware design).

FIG. 3 illustrates an example format of a fragmented packet 300 in accordance with certain embodiments. In the illustrated example, the fragmented packet 300 has a protocol-agnostic format defined with reference to the OSI model. In this manner, the format of fragmented packet 300 can be used to implement the packet fragmentation and port aggregation functionality described throughout this disclosure using any combination of communication protocols and/or technologies (e.g., physical layer 1 (L1) technologies, data link layer 2 (L2) technologies, network layer 3 (L3) technologies, and so forth).

In the illustrated example, the fragmented packet 300 includes a physical layer (L1) preamble/header 302 and a physical layer (L1) protocol data unit (PDU) 303. The physical layer (L1) PDU 303 includes a data link layer (L2) header 305, an optional network layer (L3) header 314, a fragment Header 314, a payload fragment 314, and a fragment check sequence (FCS) 315.

The various fields of fragmented packet 300 may be used for similar purposes and/or may contain similar types of information as the corresponding fields of the fragmented Ethernet packets of FIG. 2. However, the actual fields and/or values of fragmented packet 300 may vary depending on the particular protocols and technologies used in a particular implementation.

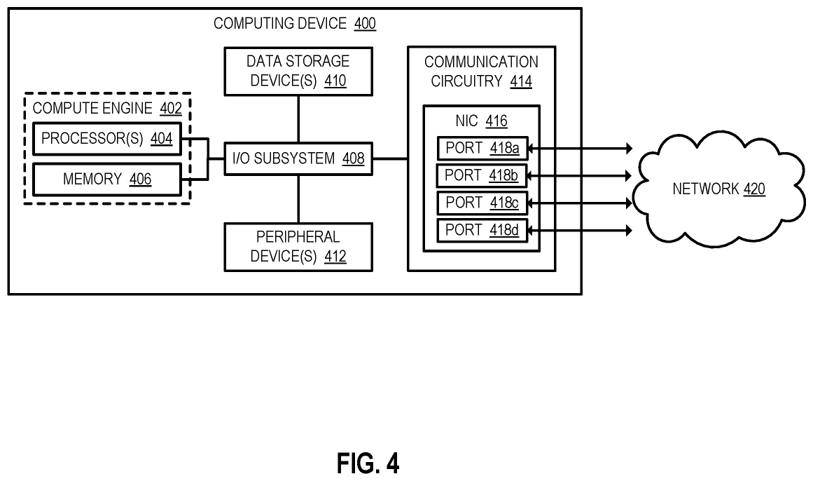

FIG. 4 illustrates an example embodiment of a computing device 400 for sending and/or receiving high-throughput network streams using packet fragmentation and port aggregation. In some embodiments, for example, computing device 400 may be used to implement the functionality of computing devices 102a,b of FIG. 1. Moreover, in various embodiments, computing device 400 may be embodied as any type of computation or computer device capable of performing the functions described herein, including, without limitation, a server (including, e.g., stand-alone server, rack-mounted server, blade server, etc.), a sled (e.g., a compute sled, an accelerator sled, a storage sled, a memory sled, etc.), an enhanced NIC (e.g., a host fabric interface (HFI)), a distributed computing system, a switch, a router, or any other combination of compute/storage/network device(s) capable of performing the functions described herein.

In the illustrated embodiment, computing device 400 includes a compute engine 402, an input/output (I/O) subsystem 408, one or more data storage devices 410, communication circuitry 414, and, in some embodiments, one or more peripheral devices 412. It should be appreciated that the computing device 400 may include other or additional components, such as those commonly found in a typical computing device (e.g., various input/output devices and/or other components), in other embodiments. Additionally, in some embodiments, one or more of the illustrative components may be incorporated in, or otherwise form a portion of, another component.

The compute engine 402 may be embodied as any type of device or collection of devices capable of performing the various compute functions as described herein. In some embodiments, the compute engine 402 may be embodied as a single device such as an integrated circuit, an embedded system, a field-programmable-array (FPGA), a system-on-a-chip (SOC), an application specific integrated circuit (ASIC), reconfigurable hardware or hardware circuitry, or other specialized hardware to facilitate performance of the functions described herein. Additionally, in some embodiments, the compute engine 402 may include, or may be embodied as, one or more processors 404 (e.g., one or more central processing units (CPUs)) and memory 406.

The processor(s) 404 may be embodied as any type of processor capable of performing the functions described herein. For example, the processor(s) 404 may be embodied as one or more single-core processors, multi-core processors, digital signal processors (DSPs), microcontrollers, or other processor(s) or processing/controlling circuit(s). In some embodiments, the processor(s) 404 may be embodied as, include, or otherwise be coupled to a field programmable gate array (FPGA), an application specific integrated circuit (ASIC), reconfigurable hardware or hardware circuitry, or other specialized hardware to facilitate performance of the functions described herein.

The memory 406 may be embodied as any type of volatile or non-volatile memory, or data storage capable of performing the functions described herein. It should be appreciated that the memory 406 may include main memory (e.g., a primary memory) and/or cache memory (e.g., memory that can be accessed more quickly than the main memory). It should be further appreciated that the volatile memory may be a storage medium that requires power to maintain the state of data stored by the medium. Non-limiting examples of volatile memory may include various types of random access memory (RAM), such as dynamic random access memory (DRAM) or static random access memory (SRAM).

The compute engine 402 is communicatively coupled to other components of the computing device 400 via the I/O subsystem 408, which may be embodied as circuitry and/or components to facilitate input/output operations with the processor 404, the memory 406, and other components of the computing device 400. For example, the I/O subsystem 408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 408 may form a portion of a system-on-a-chip (SoC) and be incorporated, along with one or more of the processor 404, the memory 406, and other components of the computing device 400, on a single integrated circuit chip.

The one or more data storage devices 410 may be embodied as any type of storage device(s) configured for short-term or long-term storage of data, such as, for example, memory devices and circuits, memory cards, hard disk drives, solid-state drives, or other data storage devices. Each data storage device 410 may include a system partition that stores data and firmware code for the data storage device 410. Each data storage device 410 may also include an operating system partition that stores data files and executables for an operating system.

The communication circuitry 414 may be embodied as any communication circuit, device, or collection thereof, capable of enabling communications between the computing device 400 and other computing devices, as well as any network communication enabling devices, such as an access point, switch, router, etc., to allow communication to/from the computing device 400 over a network 420. Accordingly, the communication circuitry 414 may be configured to use any one or more communication technologies (e.g., wireless or wired communication technologies) and associated protocols (e.g., Ethernet, Bluetooth®, Wi-Fi®, WiMAX, LTE, 5G, etc.) to effect such communication.

It should be appreciated that, in some embodiments, the communication circuitry 414 may include specialized circuitry, hardware, or combination thereof to perform pipeline logic (e.g., hardware-based algorithms) for performing the functions described herein, including processing network packets, making switching and/or routing decisions, performing computational functions, etc.

In some embodiments, performance of one or more of the functions of communication circuitry 414 as described herein may be performed by specialized circuitry, hardware, or combination thereof of the communication circuitry 414, which may be embodied as a system-on-a-chip (SoC) or otherwise form a portion of a SoC of the computing device 400 (e.g., incorporated on a single integrated circuit chip along with a processor 404, the memory 406, and/or other components of the computing device 400). Alternatively, in some embodiments, the specialized circuitry, hardware, or combination thereof may be embodied as one or more discrete processing units of the computing device 400, each of which may be capable of performing one or more of the functions described herein.

The illustrative communication circuitry 414 includes a network interface controller (NIC) 416, also commonly referred to as a host fabric interface (HFI) in some embodiments (e.g., high-performance computing (HPC) environments). The NIC 416 may include any type or combination of circuitry (e.g., processing circuitry, controller circuitry, communication circuitry) to enable communication over one or more network interfaces, such as communication via ports 418a-d with network 420 and/or other computing devices. Moreover, the NIC 416 may be embodied as one or more add-in-boards, daughtercards, network interface cards, controller chips, chipsets, or other devices. In some embodiments, the NIC 416 may be embodied as part of a system-on-a-chip (SoC) that includes one or more processors, or included on a multichip package that also contains one or more processors. In some embodiments, the NIC 416 may include other components which are not shown for clarity of the description, such as a processor, a controller, a network controller, an accelerator device (e.g., any type of specialized hardware on which operations can be performed faster and/or more efficiently than is possible on the local general-purpose processor), and/or memory. It should be appreciated that, in such embodiments, the local processor and/or accelerator device of the NIC 416 may be capable of performing one or more of the functions described herein. The NIC 416 includes multiple ports 418a-d (e.g., input/output ports), each of which may be embodied as any type of network port capable of performing the functions described herein (e.g., Ethernet ports), including transmitting and receiving data to/from the computing device 400.

The one or more peripheral devices 412 may include any type of device that is usable to input information into the computing device 400 and/or receive information from the computing device 400. The peripheral devices 412 may be embodied as any auxiliary device usable to input information into the computing device 400, such as a keyboard, a mouse, a microphone, a barcode reader, an image scanner, etc., or output information from the computing device 400, such as a display, a speaker, graphics circuitry, a printer, a projector, etc. It should be appreciated that, in some embodiments, one or more of the peripheral devices 412 may function as both an input device and an output device (e.g., a touchscreen display, a digitizer on top of a display screen, etc.). It should be further appreciated that the types of peripheral devices 412 connected to the computing device 400 may depend on, for example, the type and/or intended use of the computing device 400. Additionally or alternatively, in some embodiments, the peripheral devices 412 may include one or more ports, such as a USB port, for example, for connecting external peripheral devices to the computing device 400.

The network 420 may be embodied as any type of wired or wireless communication network, including but not limited to a wireless local area network (WLAN), a wireless personal area network (WPAN), an edge network (e.g., a multi-access edge computing (MEC) network), a fog network, a cellular network (e.g., Global System for Mobile Communications (GSM), Long-Term Evolution (LTE), 5G, etc.), a telephony network, a digital subscriber line (DSL) network, a cable network, a local area network (LAN), a wide area network (WAN), a global network (e.g., the Internet), a fabric or interconnect (e.g., a switched fabric, an HPC interconnect), or any combination thereof. It should be appreciated that, in such embodiments, the network 420 may serve as a centralized network and, in some embodiments, may be communicatively coupled to another network (e.g., the Internet). Accordingly, the network 420 may include a variety of other virtual and/or physical computing devices (e.g., routers, switches, network hubs, servers, storage devices, compute devices, etc.), as needed to facilitate the transmission of network traffic through the network 420.

Moreover, in various embodiments, certain components of computing device 400 (e.g., compute engine 402, communication circuitry 414, NIC 416, and/or ports 418a-d) may individually or collectively include functionality for sending and/or receiving high-throughput streams over the network 420 using packet fragmentation and port aggregation to spread traffic from each stream across ports 418a-d, as described further throughout this disclosure.

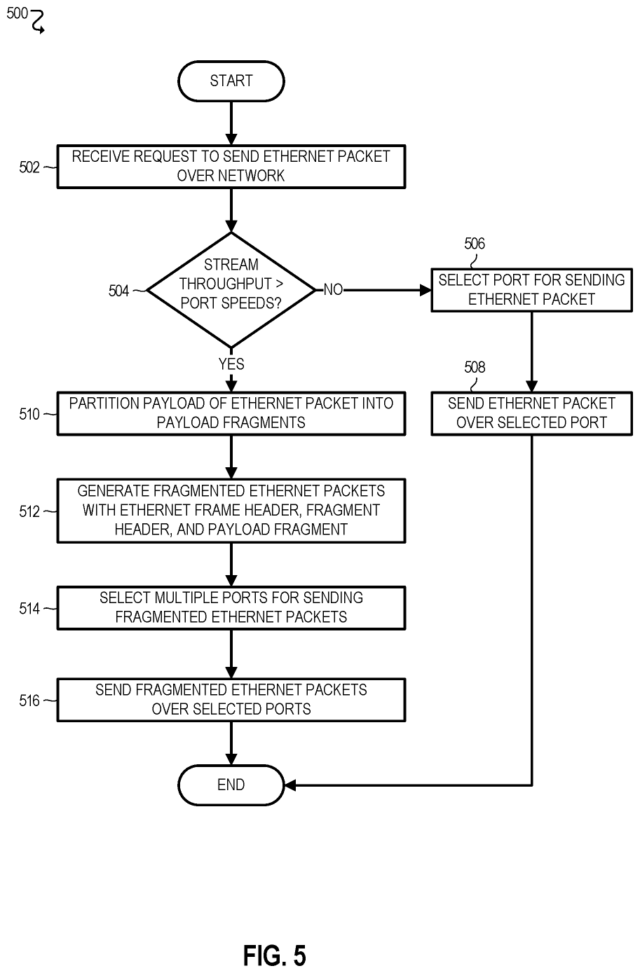

FIG. 5 illustrates a flowchart 500 for sending Ethernet packets over a network using packet fragmentation and port aggregation in accordance with certain embodiments. In some embodiments, for example, flowchart 500 may be performed by a network interface controller (NIC) (and/or any other type of communication or controller circuitry) with multiple ports (e.g., network interface controller 416 of FIG. 4), which may be part of, or associated with, a compute device, server, switch, router, and/or any other type of computing and/or networking device (e.g., computing devices 102a,b of FIG. 1, computing device 400 of FIG. 4).

The flowchart begins at block 502 by receiving a request to send an Ethernet packet (e.g., a payload encapsulated within an Ethernet frame) to a corresponding destination over a network. In some cases, for example, the request may be a request to create and send a new Ethernet packet associated with a particular data stream, or the request may be a request to forward an incoming Ethernet packet received by the NIC via one or more of its ports.

The flowchart then proceeds to block 504 to determine whether the required throughout of the stream exceeds the speeds of the available ports on the NIC. In some cases, for example, the Ethernet packet may be part of a data stream (e.g., a video stream) that has certain throughput or bandwidth requirements. Moreover, each port on the NIC may support a particular transmission speed, such as 1 Gbps, 2.5 Gbps, 25 Gbps, 40 Gbps, and so forth. Accordingly, the required throughput of the stream may be compared to the transmission speeds of the available ports to determine whether any of the ports are fast enough to meet the required throughput of the stream.

If it is determined at block 504 that the required stream throughput is within the speed of one or more available ports, the flowchart then proceeds to block 506 to select a port to use for transmission of the particular Ethernet packet, and then to block 508 to send the Ethernet packet to the corresponding destination via the selected port.

If it is determined at block 504 that the required stream throughput exceeds the speed of all available ports, the flowchart then proceeds to block 510 to leverage packet fragmentation and port aggregation techniques to send the particular Ethernet packet. For example, at block 510, the payload of the original Ethernet packet is partitioned into multiple payload fragments.

The flowchart then proceeds to block 512 to generate a collection of fragmented Ethernet packets corresponding to the payload fragments. In some embodiments, for example, each fragmented Ethernet packet may include some or all of the following:
(i) a preceding inter-packet gap (IPG) and/or and Ethernet preamble;
(ii) an Ethernet frame header with a source MAC address, destination MAC address, and/or Ethernet Type (EtherType) field (e.g., indicating the packet type as a fragmented Ethernet packet type);
(iii) a network layer header with a source IP address and/or a destination IP address;
(iv) a fragment header with a sequence number of a corresponding payload fragment, a start of frame (SOF) flag to indicate whether the corresponding payload fragment corresponds to a start of the Ethernet frame, and/or an end of frame (EOF) flag to indicate whether the corresponding payload fragment corresponds to an end of the Ethernet frame.
(v) a corresponding payload fragment; and
(vi) a fragment check sequence (FCS) (e.g., a CRC checksum calculated for the corresponding payload fragment).

In some embodiments, the MAC addresses in Ethernet frame headers of the fragmented Ethernet packets may be generated and/or assigned by: identifying a set of source MAC addresses associated with the set of selected ports (from block 514); assigning the set of source MAC addresses across the fragmented Ethernet packets (such that the source MAC address in the Ethernet frame header of each fragmented Ethernet packet is assigned from the set of source MAC addresses); identifying a set of destination MAC addresses associated with the corresponding destination; and assigning the set of destination MAC addresses across the fragmented Ethernet packets (such that the destination MAC address in the Ethernet frame header of each fragmented Ethernet packet is assigned from the set of destination MAC addresses).

The flowchart then proceeds to block 514 to select, from the set of ports on the NIC, a group of ports to be collectively used to send the fragmented Ethernet packets. In some embodiments, for example, a group of ports on the NIC may be selected and aggregated together into a single logical port or link, which can then be used to send the fragmented Ethernet packets while achieving the required level of throughput for the underlying stream. In some embodiments, for example, the particular group of ports may be selected based on their respective port speeds along with the throughput requirement(s) of the stream corresponding to the fragmented Ethernet packets. For example, the group of ports may be chosen such that their aggregated speeds are sufficient to satisfy the required throughput of the underlying data stream.

The flowchart then proceeds to block 516 to send the fragmented Ethernet packets to the corresponding destination over the network using the selected set of ports. In some embodiments, for example, the fragmented Ethernet packets can be spread across the selected set of ports using any suitable approach. In this manner, the selected set of ports are collectively used to send the fragmented packets, thus enabling the requisite throughput of the stream to be achieved.

In some embodiments, for example, the fragmented Ethernet packets may be scheduled for transmission across the set of selected ports, such that each fragmented packet is scheduled for transmission on one of the ports. In this manner, each fragmented Ethernet packet is sent to the corresponding destination over the network via the corresponding port scheduled for that packet.

Moreover, in various embodiments, the fragmented Ethernet packets can be spread, distributed, and/or scheduled across the set of selected ports using any suitable load balancing mechanism. In some embodiments, for example, the fragmented Ethernet packets may be scheduled or distributed across the set of selected ports using a round robin scheme. Alternatively, or additionally, the fragmented Ethernet packets may be scheduled or distributed across the set of selected ports using a hash stickiness scheme.

At this point, the flowchart may be complete. In some embodiments, however, the flowchart may restart and/or certain blocks may be repeated. For example, in some embodiments, the flowchart may restart at block 502 to continue receiving and processing requests to send packets over the network.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a network interface controller, comprising: a set of ports to communicate over a network; and processing circuitry to: receive a request to send an Ethernet packet to a corresponding destination over the network, wherein the Ethernet packet is to include a payload encapsulated within an Ethernet frame; partition the payload into a plurality of payload fragments; generate a plurality of fragmented Ethernet packets corresponding to the plurality of payload fragments, wherein the respective fragmented Ethernet packets comprise: a corresponding payload fragment from the plurality of payload fragments; a fragment header, wherein the fragment header comprises a sequence number of the corresponding payload fragment; and an Ethernet frame header, wherein the Ethernet frame header comprises a source media access control (MAC) address and a destination MAC address; and send, via a plurality of ports selected from the set of ports, the plurality of fragmented Ethernet packets to the corresponding destination over the network.

Example 2 includes the network interface controller of Example 1, wherein the request to send the Ethernet packet to the corresponding destination over the network comprises: a request to create and send a new Ethernet packet; or a request to forward an incoming Ethernet packet, wherein the incoming Ethernet packet is received via a corresponding port of the set of ports.

Example 3 includes the network interface controller of Example 1, wherein the processing circuitry is further to: select, from the set of ports, the plurality of ports for sending the plurality of fragmented Ethernet packets, wherein the plurality of ports are selected based on: a speed of each port in the set of ports; and a throughput requirement of a stream corresponding to the plurality of fragmented Ethernet packets.

Example 4 includes the network interface controller of Example 1, wherein the processing circuitry to send, via the plurality of ports selected from the set of ports, the plurality of fragmented Ethernet packets to the corresponding destination over the network is further to: schedule the plurality of fragmented Ethernet packets for transmission on the plurality of ports, wherein each fragmented Ethernet packet is scheduled for transmission on a corresponding port of the plurality of ports; and send each fragmented Ethernet packet to the corresponding destination over the network via the corresponding port.

Example 5 includes the network interface controller of Example 4, wherein the processing circuitry to schedule the plurality of fragmented Ethernet packets for transmission on the plurality of ports is further to: distribute the plurality of fragmented Ethernet packets across the plurality of ports based on a round robin scheme.

Example 6 includes the network interface controller of Example 1, wherein the processing circuitry to generate the plurality of fragmented Ethernet packets corresponding to the plurality of payload fragments is further to: identify a set of source MAC addresses associated with the plurality of ports; assign the set of source MAC addresses across the plurality of fragmented Ethernet packets, wherein the source MAC address in the Ethernet frame header of each fragmented Ethernet packet is assigned from the set of source MAC addresses; identify a set of destination MAC addresses associated with the corresponding destination; and assign the set of destination MAC addresses across the plurality of fragmented Ethernet packets, wherein the destination MAC address in the Ethernet frame header of each fragmented Ethernet packet is assigned from the set of destination MAC addresses.

Example 7 includes the network interface controller of Example 1, wherein the Ethernet frame header further comprises an Ethernet Type (EtherType) field, wherein the EtherType field is to indicate a fragmented Ethernet packet type.

Example 8 includes the network interface controller of Example 1, wherein the fragment header further comprises: a start of frame flag to indicate whether the corresponding payload fragment corresponds to a start of the Ethernet frame; and an end of frame flag to indicate whether the corresponding payload fragment corresponds to an end of the Ethernet frame.

Example 9 includes the network interface controller of Example 1, wherein each fragmented Ethernet packet further comprises a network layer header, wherein the network layer header comprises a source Internet Protocol (IP) address and a destination IP address.

Example 10 includes the network interface controller of Example 1, wherein the respective fragmented Ethernet packets further comprise: an Ethernet preamble; and a fragment check sequence (FCS).

Example 11 includes at least one non-transitory machine-readable storage medium having instructions stored thereon, wherein the instructions, when executed, cause communication circuitry to: receive a request to send an Ethernet packet to a corresponding destination over a network, wherein the Ethernet packet is to include a payload encapsulated within an Ethernet frame; partition the payload into a plurality of payload fragments; generate a plurality of fragmented Ethernet packets corresponding to the plurality of payload fragments, wherein the respective fragmented Ethernet packets comprise: a corresponding payload fragment from the plurality of payload fragments; a fragment header, wherein the fragment header comprises a sequence number of the corresponding payload fragment; and an Ethernet frame header, wherein the Ethernet frame header comprises a source media access control (MAC) address and a destination MAC address; and send, via a plurality of ports, the plurality of fragmented Ethernet packets to the corresponding destination over the network.

Example 12 includes the storage medium of Example 11, wherein the request to send the Ethernet packet to the corresponding destination over the network comprises: a request to create and send a new Ethernet packet; or a request to forward an incoming Ethernet packet, wherein the incoming Ethernet packet is received via a corresponding port of the set of ports.

Example 13 includes the storage medium of Example 11, wherein the instructions further cause the communication circuitry to: select, from a set of available ports, the plurality of ports for sending the plurality of fragmented Ethernet packets, wherein the plurality of ports are selected based on: a speed of each port in the set of available ports; and a throughput requirement of a stream corresponding to the plurality of fragmented Ethernet packets.

Example 14 includes the storage medium of Example 13, wherein the stream comprises a video stream.

Example 15 includes the storage medium of Example 11, wherein the instructions that cause the communication circuitry to send, via the plurality of ports, the plurality of fragmented Ethernet packets to the corresponding destination over the network further cause the communication circuitry to: schedule the plurality of fragmented Ethernet packets for transmission on the plurality of ports, wherein each fragmented Ethernet packet is scheduled for transmission on a corresponding port of the plurality of ports; and send each fragmented Ethernet packet to the corresponding destination over the network via the corresponding port.

Example 16 includes the storage medium of Example 15, wherein the instructions that cause the communication circuitry to schedule the plurality of fragmented Ethernet packets for transmission on the plurality of ports further cause the communication circuitry to: distribute the plurality of fragmented Ethernet packets across the plurality of ports based on a round robin scheme.

Example 17 includes the storage medium of Example 11, wherein the instructions that cause the communication circuitry to generate the plurality of fragmented Ethernet packets corresponding to the plurality of payload fragments further cause the communication circuitry to: identify a set of source MAC addresses associated with the plurality of ports; assign the set of source MAC addresses across the plurality of fragmented Ethernet packets, wherein the source MAC address in the Ethernet frame header of each fragmented Ethernet packet is assigned from the set of source MAC addresses; identify a set of destination MAC addresses associated with the corresponding destination; and assign the set of destination MAC addresses across the plurality of fragmented Ethernet packets, wherein the destination MAC address in the Ethernet frame header of each fragmented Ethernet packet is assigned from the set of destination MAC addresses.

Example 18 includes the storage medium of Example 11, wherein the Ethernet frame header further comprises an Ethernet Type (EtherType) field, wherein the EtherType field is to indicate a fragmented Ethernet packet type.

Example 19 includes the storage medium of Example 11, wherein the fragment header further comprises: a start of frame flag to indicate whether the corresponding payload fragment corresponds to a start of the Ethernet frame; and an end of frame flag to indicate whether the corresponding payload fragment corresponds to an end of the Ethernet frame.

Example 20 includes the storage medium of Example 11, wherein each fragmented Ethernet packet further comprises a network layer header, wherein the network layer header comprises a source Internet Protocol (IP) address and a destination IP address.

Example 21 includes the storage medium of Example 11, wherein each fragmented Ethernet packet further comprises a fragment check sequence (FCS).

Example 22 includes the storage medium of Example 11, wherein each fragmented Ethernet packet further comprises an Ethernet preamble.

Example 23 includes a computing device for sending an Ethernet packet over a network, comprising: a host processor; a set of ports to communicate over the network; and communication circuitry to: receive, from the host processor, a request to send the Ethernet packet to a corresponding destination over the network, wherein the Ethernet packet is to include a payload encapsulated within an Ethernet frame; partition the payload into a plurality of payload fragments; generate a plurality of fragmented Ethernet packets corresponding to the plurality of payload fragments, wherein the respective fragmented Ethernet packets comprise: a corresponding payload fragment from the plurality of payload fragments; a fragment header, wherein the fragment header comprises a sequence number of the corresponding payload fragment; and an Ethernet frame header, wherein the Ethernet frame header comprises a source media access control (MAC) address and a destination MAC address; and send, via a plurality of ports selected from the set of ports, the plurality of fragmented Ethernet packets to the corresponding destination over the network.

Example 24 includes the computing device of Example 23, wherein the computing device is a compute server or a network switch.

Example 25 includes a method of sending an Ethernet packet over a network, comprising: receiving a request to send the Ethernet packet to a corresponding destination over the network, wherein the Ethernet packet is to include a payload encapsulated within an Ethernet frame; partitioning the payload into a plurality of payload fragments; generating a plurality of fragmented Ethernet packets corresponding to the plurality of payload fragments, wherein the respective fragmented Ethernet packets comprise: a corresponding payload fragment from the plurality of payload fragments; a fragment header, wherein the fragment header comprises a sequence number of the corresponding payload fragment; and an Ethernet frame header, wherein the Ethernet frame header comprises a source media access control (MAC) address and a destination MAC address; and sending, via a plurality of ports, the plurality of fragmented Ethernet packets to the corresponding destination over the network.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A network interface controller, comprising:
a set of ports to communicate over a network; and
processing circuitry to:
receive a request to send an Ethernet packet to a corresponding destination over the network, wherein the Ethernet packet is to include a payload encapsulated within an Ethernet frame;
partition the payload into a plurality of payload fragments;
generate a plurality of fragmented Ethernet packets corresponding to the plurality of payload fragments, wherein the respective fragmented Ethernet packets comprise:
a corresponding payload fragment from the plurality of payload fragments;
a fragment header, wherein the fragment header comprises a sequence number of the corresponding payload fragment; and
an Ethernet frame header, wherein the Ethernet frame header comprises a source media access control (MAC) address and a destination MAC address; and
send, via a plurality of ports selected from the set of ports, the plurality of fragmented Ethernet packets to the corresponding destination over the network.

2. The network interface controller of claim 1, wherein the request to send the Ethernet packet to the corresponding destination over the network comprises:
a request to create and send a new Ethernet packet; or
a request to forward an incoming Ethernet packet, wherein the incoming Ethernet packet is received via a corresponding port of the set of ports.

3. The network interface controller of claim 1, wherein the processing circuitry is further to:
select, from the set of ports, the plurality of ports for sending the plurality of fragmented Ethernet packets, wherein the plurality of ports are selected based on:
a speed of each port in the set of ports; and
a throughput requirement of a stream corresponding to the plurality of fragmented Ethernet packets.

4. The network interface controller of claim 1, wherein the processing circuitry to send, via the plurality of ports selected from the set of ports, the plurality of fragmented Ethernet packets to the corresponding destination over the network is further to:
schedule the plurality of fragmented Ethernet packets for transmission on the plurality of ports, wherein each fragmented Ethernet packet is scheduled for transmission on a corresponding port of the plurality of ports; and
send each fragmented Ethernet packet to the corresponding destination over the network via the corresponding port.

5. The network interface controller of claim 4, wherein the processing circuitry to schedule the plurality of fragmented Ethernet packets for transmission on the plurality of ports is further to:
distribute the plurality of fragmented Ethernet packets across the plurality of ports based on a round robin scheme.

6. The network interface controller of claim 1, wherein the processing circuitry to generate the plurality of fragmented Ethernet packets corresponding to the plurality of payload fragments is further to:
identify a set of source MAC addresses associated with the plurality of ports;
assign the set of source MAC addresses across the plurality of fragmented Ethernet packets, wherein the source MAC address in the Ethernet frame header of each fragmented Ethernet packet is assigned from the set of source MAC addresses;
identify a set of destination MAC addresses associated with the corresponding destination; and
assign the set of destination MAC addresses across the plurality of fragmented Ethernet packets, wherein the destination MAC address in the Ethernet frame header of each fragmented Ethernet packet is assigned from the set of destination MAC addresses.

7. The network interface controller of claim 1, wherein the Ethernet frame header further comprises an Ethernet Type (EtherType) field, wherein the EtherType field is to indicate a fragmented Ethernet packet type.

8. The network interface controller of claim 1, wherein the fragment header further comprises:
a start of frame flag to indicate whether the corresponding payload fragment corresponds to a start of the Ethernet frame; and
an end of frame flag to indicate whether the corresponding payload fragment corresponds to an end of the Ethernet frame.

9. The network interface controller of claim 1, wherein each fragmented Ethernet packet further comprises a network layer header, wherein the network layer header comprises a source Internet Protocol (IP) address and a destination IP address.

10. The network interface controller of claim 1, wherein the respective fragmented Ethernet packets further comprise:
an Ethernet preamble; and
a fragment check sequence (FCS).

11. At least one non-transitory machine-readable storage medium having instructions stored thereon, wherein the instructions, when executed, cause communication circuitry to:
receive a request to send an Ethernet packet to a corresponding destination over a network, wherein the Ethernet packet is to include a payload encapsulated within an Ethernet frame;
partition the payload into a plurality of payload fragments;
generate a plurality of fragmented Ethernet packets corresponding to the plurality of payload fragments, wherein the respective fragmented Ethernet packets comprise:
a corresponding payload fragment from the plurality of payload fragments;
a fragment header, wherein the fragment header comprises a sequence number of the corresponding payload fragment; and
an Ethernet frame header, wherein the Ethernet frame header comprises a source media access control (MAC) address and a destination MAC address; and
send, via a plurality of ports, the plurality of fragmented Ethernet packets to the corresponding destination over the network.

12. The storage medium of claim 11, wherein the request to send the Ethernet packet to the corresponding destination over the network comprises:
a request to create and send a new Ethernet packet; or
a request to forward an incoming Ethernet packet, wherein the incoming Ethernet packet is received via a corresponding port of the set of ports.

13. The storage medium of claim 11, wherein the instructions further cause the communication circuitry to:
select, from a set of available ports, the plurality of ports for sending the plurality of fragmented Ethernet packets, wherein the plurality of ports are selected based on:
a speed of each port in the set of available ports; and
a throughput requirement of a stream corresponding to the plurality of fragmented Ethernet packets.

14. The storage medium of claim 13, wherein the stream comprises a video stream.

15. The storage medium of claim 11, wherein the instructions that cause the communication circuitry to send, via the plurality of ports, the plurality of fragmented Ethernet packets to the corresponding destination over the network further cause the communication circuitry to:
schedule the plurality of fragmented Ethernet packets for transmission on the plurality of ports, wherein each fragmented Ethernet packet is scheduled for transmission on a corresponding port of the plurality of ports; and
send each fragmented Ethernet packet to the corresponding destination over the network via the corresponding port.

16. The storage medium of claim 15, wherein the instructions that cause the communication circuitry to schedule the plurality of fragmented Ethernet packets for transmission on the plurality of ports further cause the communication circuitry to:
distribute the plurality of fragmented Ethernet packets across the plurality of ports based on a round robin scheme.

17. The storage medium of claim 11, wherein the instructions that cause the communication circuitry to generate the plurality of fragmented Ethernet packets corresponding to the plurality of payload fragments further cause the communication circuitry to:
identify a set of source MAC addresses associated with the plurality of ports;
assign the set of source MAC addresses across the plurality of fragmented Ethernet packets, wherein the source MAC address in the Ethernet frame header of each fragmented Ethernet packet is assigned from the set of source MAC addresses;
identify a set of destination MAC addresses associated with the corresponding destination; and
assign the set of destination MAC addresses across the plurality of fragmented Ethernet packets, wherein the destination MAC address in the Ethernet frame header of each fragmented Ethernet packet is assigned from the set of destination MAC addresses.

18. The storage medium of claim 11, wherein the Ethernet frame header further comprises an Ethernet Type (EtherType) field, wherein the EtherType field is to indicate a fragmented Ethernet packet type.

19. The storage medium of claim 11, wherein the fragment header further comprises:
a start of frame flag to indicate whether the corresponding payload fragment corresponds to a start of the Ethernet frame; and
an end of frame flag to indicate whether the corresponding payload fragment corresponds to an end of the Ethernet frame.

20. The storage medium of claim 11, wherein each fragmented Ethernet packet further comprises a network layer header, wherein the network layer header comprises a source Internet Protocol (IP) address and a destination IP address.

21. The storage medium of claim 11, wherein the respective fragmented Ethernet packets further comprise:
an Ethernet preamble; and
a fragment check sequence (FCS).

22. A computing device for sending an Ethernet packet over a network, comprising:
a host processor;
a set of ports to communicate over the network; and
communication circuitry to:
receive, from the host processor, a request to send the Ethernet packet to a corresponding destination over the network, wherein the Ethernet packet is to include a payload encapsulated within an Ethernet frame;
partition the payload into a plurality of payload fragments;
generate a plurality of fragmented Ethernet packets corresponding to the plurality of payload fragments, wherein the respective fragmented Ethernet packets comprise:
a corresponding payload fragment from the plurality of payload fragments;
a fragment header, wherein the fragment header comprises a sequence number of the corresponding payload fragment; and
an Ethernet frame header, wherein the Ethernet frame header comprises a source media access control (MAC) address and a destination MAC address; and
send, via a plurality of ports selected from the set of ports, the plurality of fragmented Ethernet packets to the corresponding destination over the network.

23. The computing device of claim 22, wherein the computing device is a compute server or a network switch.

24. A method of sending an Ethernet packet over a network, comprising:
receiving a request to send the Ethernet packet to a corresponding destination over the network, wherein the Ethernet packet is to include a payload encapsulated within an Ethernet frame;
partitioning the payload into a plurality of payload fragments;
generating a plurality of fragmented Ethernet packets corresponding to the plurality of payload fragments, wherein the respective fragmented Ethernet packets comprise:
a corresponding payload fragment from the plurality of payload fragments;
a fragment header, wherein the fragment header comprises a sequence number of the corresponding payload fragment; and
an Ethernet frame header, wherein the Ethernet frame header comprises a source media access control (MAC) address and a destination MAC address; and
sending, via a plurality of ports, the plurality of fragmented Ethernet packets to the corresponding destination over the network.

25. The method of claim 24, further comprising:
selecting, from a set of available ports, the plurality of ports for sending the plurality of fragmented Ethernet packets, wherein the plurality of ports are selected based on:
a speed of each port in the set of available ports; and
a throughput requirement of a stream corresponding to the plurality of fragmented Ethernet packets.
